(19) United States
(12) Patent Application Publication
(10) Pub. No.: US 2005/0133009 A1
(43) Pub. Date: Jun. 23, 2005

(54) Runnerless engine intake manifold having integral fuel delivery groove

(76) Inventors: Robert Rowells, Elmwood Park, IL (US); Gregory Saele, Itasca, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/745,435

(22) Filed: Dec. 23, 2003

(51) Int. Cl. F02M 35/10

(52) U.S. Cl. 123/456; 123/184.21

(57) ABSTRACT

A cylinder head (10) and a runnerless intake manifold (12) assembled together cooperatively define an air manifold (14) and a fuel manifold (16) for supplying air and fuel respectively to engine cylinders in an engine block to which cylinder head (10) is fastened.

### FIELD OF THE INVENTION

This invention relates to internal combustion engines, particularly to engine air and fuel systems.

### BACKGROUND OF THE INVENTION

An air system of an internal combustion engine conveys combustion air to combustion chambers where the air forms part of an air-fuel mixture that is compressed and combusted to power the engine. Combustion chambers of an in-line, reciprocating piston engine are cylinders that are cooperatively defined by a succession of parallel cylinder bores and a cylinder head that closes open ends of the cylinder bores. When such an engine has a cylinder block, the cylinder head is fastened and sealed to a face of the block containing the open cylinder bore ends. When such an engine is a wet sleeved engine, the cylinder head is fastened and sealed to the crankcase and the open ends of the sleeves that form the cylinder bores. Intake valves mounted on the cylinder head open at proper times during engine cycles to allow air that has passed through the air system to be admitted to the cylinders.

A fuel system of a diesel engine comprises fuel injectors that inject fuel into engine cylinders at proper times during engine cycles. Fuel under pressure may be delivered to the fuel injectors through a fuel manifold, or fuel rail, that serves multiple fuel injectors.

An intake manifold is a part of an engine air system that associates with a cylinder head to distribute air to the engine intake valves. Known intake manifolds comprise runners from a plenum to the intake valves of individual engine cylinders.

Fuel rails and intake manifolds are typically separate parts.

### SUMMARY OF THE INVENTION

Briefly, the present invention relates to improvements in air and fuel delivery in an intake manifold mounted on a cylinder head in an internal combustion engine. The improvements arise through integration of certain features in the intake manifold in cooperation with its mounting on the head. Various economies and savings are obtained as a result.

The foregoing, along with further features and advantages of the invention, will be seen in the following disclosure of a preferred embodiment of the invention depicting the best mode contemplated at this time for carrying out the invention. This specification includes drawings, now briefly described as follows.

### BRIEF DESCRIPTION OF THE DRAWINGS

FIG. 1 is a perspective view of a cylinder head by itself.

FIG. 2 is a perspective view of the cylinder head with an associated intake manifold.

FIG. 3 is a perspective view of the intake manifold by itself in the direction of its interior.

FIG. 4 is a cross section view taken along section line 4-4 in FIG. 2, but showing a modified embodiment.

### DESCRIPTION OF THE PREFERRED EMBODIMENT

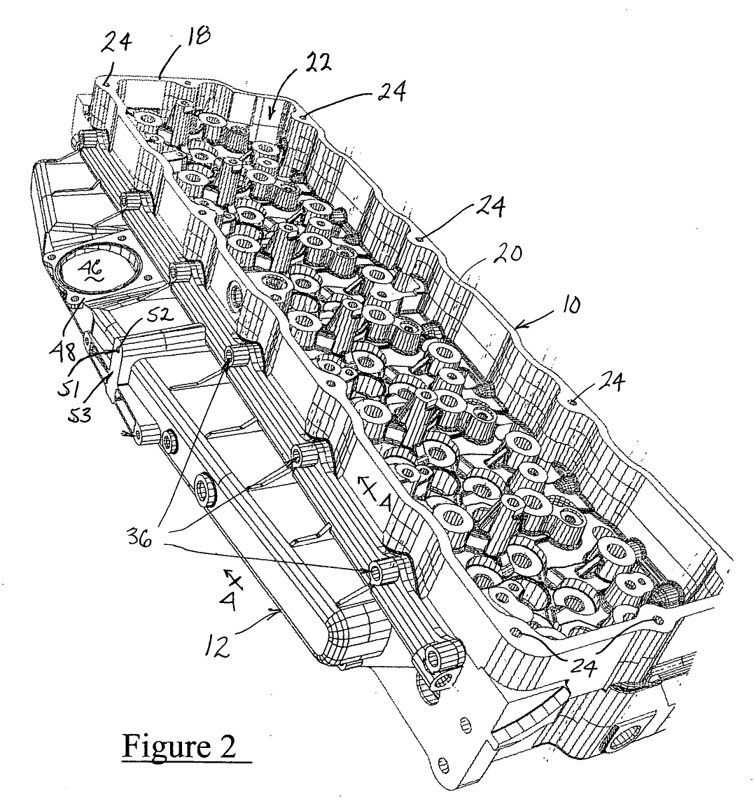

An internal combustion engine embodying principles of the present invention comprises a cylinder head 10 and a runnerless intake manifold 12. When the latter is assembled to the former as in FIGS. 2 and 4, the two parts cooperatively define an air manifold 14 and a fuel manifold 16 for supplying air and fuel respectively to the engine cylinders (not shown) whose open ends are closed by cylinder head 10. Head 10 is representative of a design for an in-line, six-cylinder diesel engine.

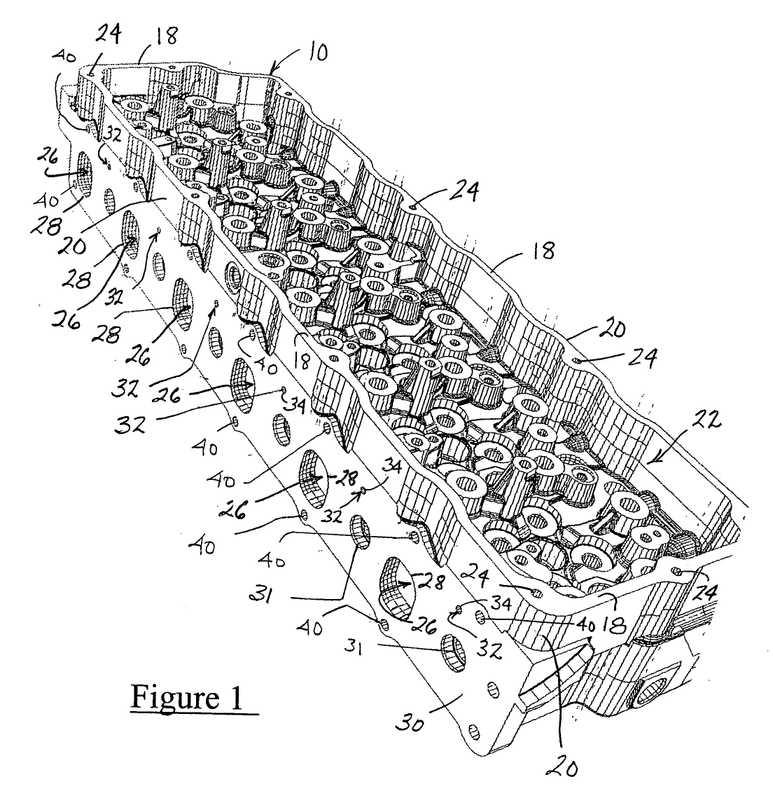

As can be understood from FIGS. 1 and 2, head 10 is shown without intake and exhaust valves for the respective cylinders, but both Figures show features of construction for accepting the valves and related mechanism for operating them.

Head 10 comprises a generally upright rectangular perimeter wall 20 surrounding an open space 22. Wall 20 has a flat edge surface 18 to which a mating edge of a valve cover (not shown) fits to enclose space 22 where the valve operating mechanism is located. When head 10 is assembled into a wet sleeved engine to close the open ends of the sleeves, head 10 seals to the sleeves and crankcase. Head 10 comprises a series of tapped blind holes 24 in wall 20 via which fasteners (not shown) attach the valve cover to the head.

Head 10 further comprises six air ports 26 having entrances 28 in a surface 30 that continues from one of the two longer sides of wall 20 in the direction away from edge 18. Entrances 28 are spaced apart along the length of surface 30. Each port 26 forms a passageway that extends within head 10 from its entrance 28 to an entrance of the intake valve (or valves in the case of a multi-valve engine) of the corresponding cylinder. Plugged core clean-out holes 31 are shown in FIG. 1, but they do not pertain to the subject matter of this invention.

Head 10 further comprises six fuel ports 32 having entrances 34 in surface 30. Entrances 34 are spaced apart along the length of surface 30 on an imaginary straight line that is spaced from the nearest edges of air port entrances 28. Each port 32 forms a passageway that extends within head 10 from its entrance 34 to an exit that opens to the fuel inlet of a respective fuel injector (not shown) for the respective cylinder.

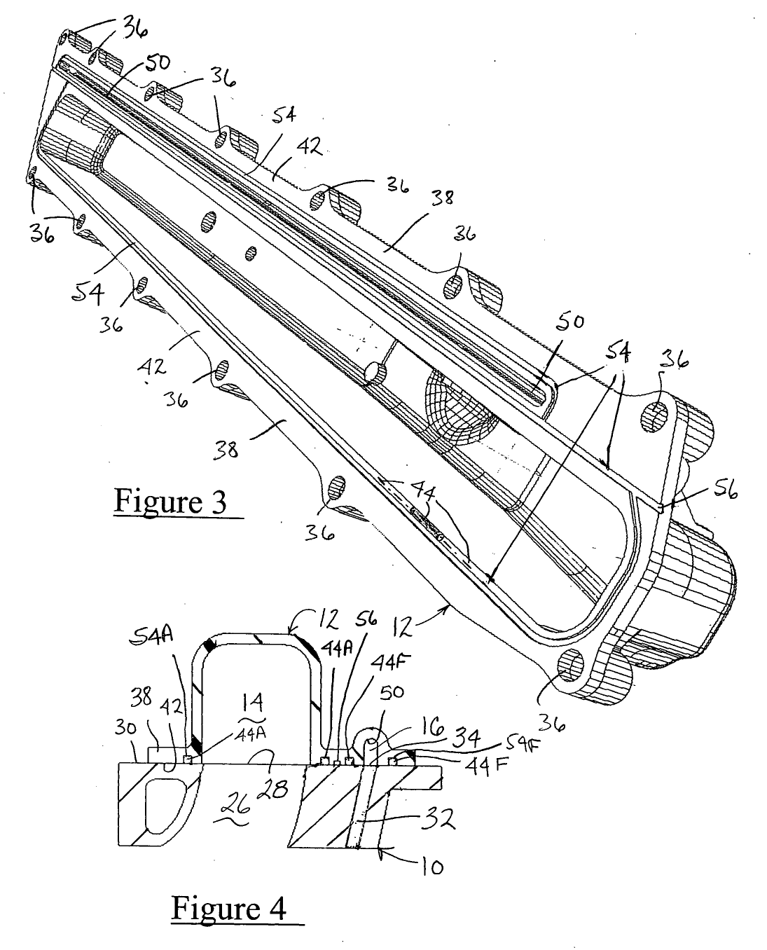

Air manifold 14 is formed by constructing intake manifold 12 to have a walled hollow interior space that is open to all air ports 26 with manifold 12 assembled to head 10. Fasteners (not shown) pass through holes 36 in bosses in a perimeter flange 38 and are tightened in threaded holes 40 extending into head 10 from surface 30. This forces a surface 42 of perimeter flange 38 against surface 30, with an endless portion of a one-piece seal 44 that has been disposed between the two faces sealing around air manifold 14. Seal 44 is only partially shown in FIG. 3 for clarity of illustration.

Intake manifold 12 further comprises an air inlet 46 that is provided by a circular through-hole somewhere along the length of air manifold 14 in one of the walls enclosing the hollow interior space that forms air manifold 14. At air inlet 46 the exterior of that wall has an attachment face 48 for attaching a part (not shown) of the air system through which air is introduced into air manifold 14. In this way, air passing through the air system is distributed to the individual air ports 26 in head 10 without an individual runner to each air port.

Fuel manifold 16 is formed by constructing intake manifold 12 to have a groove 50 that runs along a portion of flange 38 in surface 42 and is open to all fuel ports 32. With surfaces 42 and 30 being forced together by the fastening of intake manifold 12 to head 10, another endless portion of seal 44 seals around fuel manifold 14.

Fuel from a source such as a pump is introduced into fuel manifold 16 through a fuel inlet port 52 that has an entrance 51 at a fuel filter mounting pad surface 53 on the exterior of intake manifold 12. Port 52 forms an internal passageway that extends within the wall of intake manifold 12 to intersect groove 50. In this way, fuel passing through the fuel system is filtered by a filter (not shown) on pad surface 53, introduced into port 52 where it is conveyed to groove 50 for distribution to the individual fuel ports 32 in head 10 without an individual runner or line to each fuel port.

Seal 44 fits into a groove 54 in surface 42. The seal is a single piece having two endless portions, one of which seals around air manifold 12 and the other of which seals around fuel manifold 14. It can be understood that in such a one-piece seal the two endless portions share a common segment of the seal between the two manifolds 12, 14. Hence the layout of seal 44 matches that of groove 54, but the groove layout also has a shunt 56 not occupied by seal 44. In the unlikely event that seal 44 were mistakenly omitted or improperly placed before intake manifold 12 and head 10 were assembled together, shunt 56 would be effective to shunt leaking fuel away from air manifold 14.

FIG. 4 is representative of a modified embodiment that has two separate seals 44A, 44F. Intake manifold 12 has two separate seal grooves 54A, 54F in surface 42. Each seal groove 54A, 54F surrounds a respective one of manifolds 14, 16, with each endless seal 44A, 44F fitting in a respective groove 54A, 54F. Running parallel with the long dimension of each seal groove, and between the two seal grooves, in surface 42, is a groove that forms a shunt 56 that serves the same purpose as shunt 56 in the embodiments of FIG. 1, 2, and 3. Leaking fuel from fuel manifold 16 will be carried away from air manifold 14 by shunt 56.

Because only a single manifold part that delivers both fuel and air need be assembled to the head, the invention provides a number of advantages including savings in machining operations, assembly time, space, fasteners, servicing, and parts inventory. An intake manifold 12 may be fabricated by known manufacturing methods using known materials. For example, it may be fabricated by casting or molding, and subsequently finished using suitable finishing and/or machining techniques. Suitable materials include both metals and synthetics.

While a presently preferred embodiment of the invention has been illustrated and described, it should be appreciated that principles of the invention apply to all embodiments falling within the scope of the following claims.

1. A combined air intake manifold and fuel rail for an internal combustion engine comprising a hollow portion defining an air channel with an open face, and a mounting flange portion having a recess in an underside thereof defining a fuel delivery channel, said manifold adapted to be installed on an engine head with the open face of the air intake channel positioned over a series of air intake ports and the fuel delivery channel overlying an array of fuel inlet openings in the engine head:

2. A combined air manifold and fuel rail according to claim 1, formed of molded synthetic resin material.

3. A combined air manifold and fuel rail according to claim 1, further comprising a seal member for sealing the manifold and fuel rail to the engine head when installed thereon.

4. canceled

5. An internal combustion engine comprising:
a head for multiple engine cylinders,
an intake manifold assembled to the head, and
separate fuel and air manifolds cooperatively defined between confronting surfaces of the head and the intake manifold for conveying fuel and air to the cylinders.

6. An engine as set forth in claim 5 including respective endless seals disposed between the confronting surfaces for sealing around the fuel manifold and the air manifold respectively.

7. An engine as set forth in claim 6 wherein the seals are respective portions of a one-piece seal.

8. An engine as set forth in claim 6 wherein the seals are separate from each other.

9. An engine as set forth in claim 6 wherein the fuel manifold comprises a groove in the intake manifold and the air manifold comprises a walled hollow interior space in the intake manifold.

10. An engine as set forth in claim 9 wherein the head comprises discrete fuel ports having entrances in communication with the fuel manifold groove.

11. A runnerless intake manifold for assembly to a multi-cylinder head in an internal combustion engine, the intake manifold comprising:
a walled hollow interior space and a groove adapted to cooperate with the head to define separate fuel and air manifolds between confronting surfaces of the head and the intake manifold when the intake manifold is assembled to the head.

12. An intake manifold as set forth in claim 11 further comprising a groove for accepting respective endless seals to seal around the fuel manifold and the air manifold respectively between the confronting surfaces.
